(19) United States
(12) Patent Application Publication
(10) Pub. No.: US 2026/0057490 A1
(43) Pub. Date: Feb. 26, 2026

(54) IMAGE ANALYSIS METHOD AND IMAGE ANALYSIS SYSTEM

(71) Applicant: VIA TECHNOLOGIES, INC., New Taipei City (TW)

(72) Inventors: Ziye ZHOU, Beijing (CN); Ting WANG, Beijing (CN); Li FANG, Beijing (CN); Jiao LI, Beijing (CN); Chao-Chin CHANG, New Taipei City (TW)

(21) Appl. No.: 19/303,566

(22) Filed: Aug. 19, 2025

(30) Foreign Application Priority Data
Aug. 21, 2024 (CN) 202411151296.7

(51) Int. Cl. G06T 5/60; G06T 5/70; G06T 5/73; G06T 5/94

(52) U.S. Cl. CPC G06T 5/60; G06T 5/70; G06T 5/73; G06T 5/94; G06T 2207/20081

(57) ABSTRACT

An image analysis method is provided. The method includes inputting an original image into a parameter extraction model having been pre-trained to obtain multiple parameter arrays corresponding to the original image, which are output by the parameter extraction model. The method further includes using the parameter arrays to perform a sequence of image enhancement operations on the original image to obtain an enhanced image. The method further includes inputting the enhanced image into an image analysis model having been pre-trained to obtain an inference result output by the image analysis model.

### CROSS REFERENCE TO RELATED APPLICATIONS

This application claims priority of China Patent Application No. 202411151296.7, filed on Aug. 21, 2024, the entirety of which is incorporated by reference herein.

### BACKGROUND OF THE INVENTION

### Field of the Invention

The present invention relates to image analysis and machine learning techniques, and, in particular, it relates to an image analysis method and an image analysis system.

### Description of the Related Art

Image analysis is the extraction of meaningful information from images, which involves tasks such as object detection, object recognition, and distance/depth estimation, etc. Currently, these tasks are typically performed by corresponding machine learning models. However, in some special cases, such as images taken in low-visibility conditions, the performance of the model may be affected. Therefore, in practice, image enhancement techniques are required to improve image quality and thus enhance model performance.

Conventional image enhancement algorithms employ histogram equalization or gamma correction to enhance the brightness of the entire image. However, images captured at night generally suffer from low brightness and low overall pixel values, making it difficult to preserve image details after enhancement. The presence of light sources such as vehicle headlights and streetlamps in nighttime scenes often introduces interference that amplifies noise and causes overexposure, ultimately hindering the performance of image analysis models.

Additionally, some algorithms—such as maximum entropy threshold segmentation—separate an image into bright and dark regions and enhance each using different functions. However, this method has some drawbacks. First, the enhanced image may appear unsmooth, especially in cases near the threshold. Second, the parameters of the function are usually set based on human experience, which may result in the enhanced image not necessarily being adapted to the needs of the image analysis model to perform a specific task.

There are also some deep learning methods that extract features from the image, determine the parameters of the filter based on the extracted features, and then apply the filter to enhance the entire image without distinction. However, this method cannot ensure that the parameters of the filter actively adapt to the image analysis model, and similar to the conventional image enhancement algorithms, it often amplifies image noise and causes overexposure near light source, thereby impairing the effectiveness of the image analysis model.

In view of the technical challenges outlined above, there is a need for an image analysis system that incorporates an image enhancement model capable of pixel-wise enhancement and dynamic adaptation to the image analysis model.

### BRIEF SUMMARY OF THE INVENTION

The embodiment of this disclosure provides an image analysis system, including a storage unit and a processing unit. The processing unit loads a program from the storage unit to execute an image enhancement module and an image analysis module. The image enhancement module is configured to input an original image into a parameter extraction model having been pre-trained, and to obtain a plurality of parameter arrays corresponding to the original image output by the parameter extraction model, and to perform a sequence of image enhancement operations on the original image using the parameter arrays to obtain an enhanced image. Each parameter array shares the same resolution as the original image, where each element represents a parameter used to perform an image enhancement operation on the corresponding pixel. The image analysis module is configured to input the enhanced image into an image analysis model having been pre-trained, and to obtain an inference result output by the image analysis model.

In one of the embodiments, the parameter extraction model and the image analysis model are trained using a same loss function. In a further embodiment, the processing unit is further configured to execute a model building module, and to utilize the loss function along with a training dataset for training the parameter extraction model and the image analysis model, wherein the training dataset includes a plurality of training data, and each training data includes a training image and label data corresponding to the training image.

In one of the embodiments, the image enhancement operations include a denoising operation. The parameter arrays include a first parameter array for performing the denoising operation.

In one of the embodiments, the image enhancement operations include a contrast adjustment operation. Additionally, the parameter arrays include a second parameter array for performing the contrast adjustment operation.

In one of the embodiments, the image enhancement operations include a brightness adjustment operation. Additionally, the parameter arrays include a third parameter array for performing the brightness adjustment operation.

In one of the embodiments, the image enhancement operations include a sharpening operation. Additionally, the parameter arrays include a fourth parameter array for performing the sharpening operation.

In one of the embodiments, the parameter arrays include the first parameter array, the second parameter array, the third parameter array and the fourth parameter array, the image enhancement operations include a denoising operation, a contrast adjustment operation, a brightness adjustment operation and a sharpening operation. In addition, the processing unit is configured to use the first parameter array to perform the denoising operation on the original image to obtain a denoised image, to use the second parameter array and the third parameter array to perform the contrast adjustment operation and the brightness adjustment operation on the denoised image respectively to obtain an adjusted image, and to use the fourth parameter array to perform the sharpening operation on the adjusted image to obtain the enhanced image.

In one of the embodiments, the original image satisfies at least one of the following conditions: (1) the signal-to-noise ratio is lower than a specified signal-to-noise ratio threshold; (2) the contrast is lower than a specified contrast threshold; (3) the image contains an overexposed area, a brightness value of each pixel in the overexposed area is higher than a specified brightness threshold; and (4) the sharpness is lower than a specified sharpness threshold.

The disclosed embodiments provide an image analysis system, including an image enhancement circuit and an image analysis circuit that are coupled to each other. The image enhancement circuit is configured to input an original image into a parameter extraction model having been pre-trained, to obtain a plurality of parameter arrays corresponding to the original image output by the parameter extraction model, and to perform a sequence of image enhancement operations on the original image using the parameter arrays to obtain an enhanced image, wherein each parameter array shares the same resolution as the original image, each element of the parameter array is a parameter required to perform an image enhancement operation corresponding to the parameter array on the corresponding pixel of the original image. An image analysis circuit is coupled to the image enhancement circuit and is configured to input the enhanced image into an image analysis model having been pre-trained to obtain an inference result output by the image analysis model.

The embodiment disclosed in this disclosure further provides an image analysis method, includes inputting an original image into a parameter extraction model having been pre-trained to obtain a plurality of parameter arrays corresponding to the original image output by the parameter extraction model. The method further includes performing a sequence of image enhancement operations on the original image using the parameter arrays to obtain an enhanced image. Each parameter array has the same resolution as the original image, each element of the parameter array is a parameter required to perform an image enhancement operation corresponding to the parameter array on the corresponding pixel of the original image. The method further includes inputting the enhanced image into an image analysis model having been pre-trained to obtain an inference result output by the image analysis model.

### BRIEF DESCRIPTION OF THE DRAWINGS

This disclosure can be more fully understood by reading the subsequent detailed description and examples with references made to the accompanying drawings. In addition, it should be understood that in the flowchart of this disclosure, the order in which blocks are executed may be changed, and/or certain blocks may be changed, deleted or merged.

FIG. 1A is a flowchart of an image enhancement method based on one of the embodiments of this disclosure.

FIG. 1B is a schematic diagram of the flow of the image enhancement method corresponding to FIG. 1A.

FIG. 2A illustrates a flowchart of one of the more detailed operations for obtaining an enhanced image by using a parameter array to perform image enhancement operations on the original image in one of the embodiments.

FIG. 2B, corresponding to FIG. 2A, depicts a more detailed schematic diagram of the flow using a parameter array to enhance the original image to obtain an enhanced image.

FIG. 3 is a system block diagram of an image analysis system based on one of the embodiments of this disclosure.

FIG. 4 is a system block diagram of an image analysis system based on one of the embodiments of this disclosure.

### DETAILED DESCRIPTION OF THE INVENTION

The following description enumerates various embodiments of the present invention, but it is not intended to limit the scope of the invention. The actual scope of the invention is defined by the claims of the patent application.

In the embodiments listed below, identical or similar elements or components will be designated by the same reference numerals.

In this specification and in the claims of the patent application, ordinal numbers such as “first,” “second,” and the like are used merely for convenience of description, and there is no sequential order or priority relationship between them.

The following description of the embodiments of the apparatus or system also applies to the embodiments of the method and vice versa.

The inventor discovered that conventional schemes perform image enhancement uniformly across the entire image. Consequently, in nighttime scenes with light sources such as streetlights and headlights, enhancing the brightness of the dark areas may also result in excessive enhancement of light source regions, leading to overexposure. In addition, when the target object to be recognized in an application scenario has similar characteristics to the background—such as color, brightness, or texture—uniform image enhancement across the entire image may be ineffective in enhancing local regions, resulting in suboptimal object detection performance. After research, the inventor proposes an image enhancement method and system that can implement pixel-wise enhancement and actively adapt to the image analysis model thereby overcoming the limitations of conventional schemes. Additionally, the parameter extraction model and image analysis model trained by the method disclosed in this document may be deployed on edge devices or terminal devices (e.g., downloaded from the cloud or ported via storage devices). In addition to providing economic benefits by eliminating the need for additional hardware, these edge devices or computers may operate independently during the model inference/application phases without requiring high computational support from the cloud, thereby also achieving the goal of enterprise information confidential.

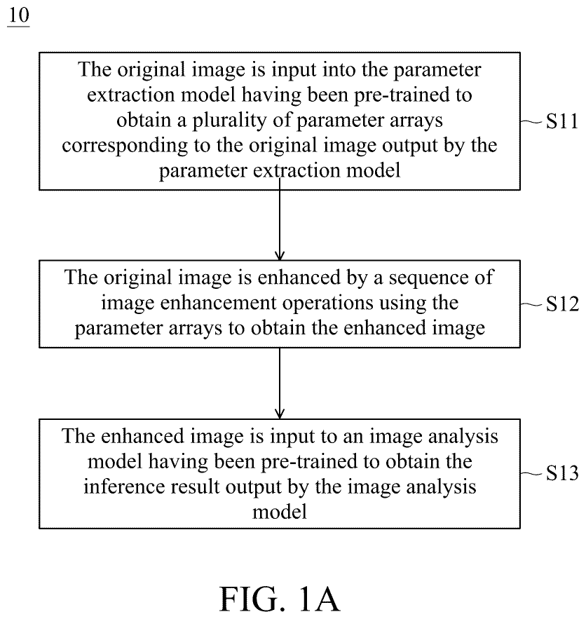

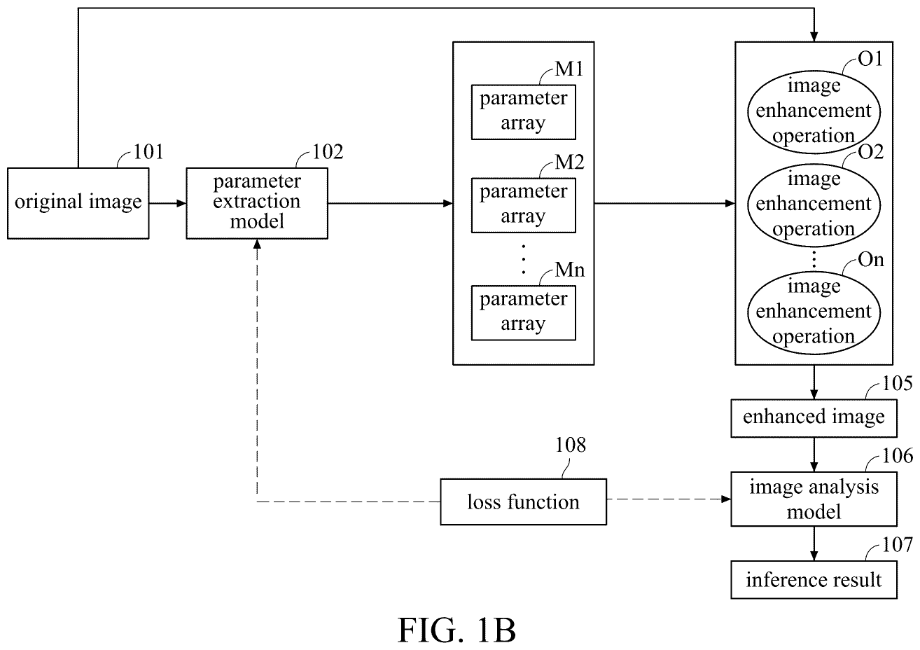

FIG. 1A is a block diagram of an image enhancement method 10 according to one embodiments of this disclosure. FIG. 1B is a schematic diagram corresponding to image enhancement method 10 of FIG. 1A. Please refer to FIG. 1A and FIG. 1B together for a better understanding of the embodiments of this disclosure. As shown in FIG. 1A, image enhancement method 10 contains operations S11-S13.

In operation S11, the original image 101 is input into the parameter extraction model 102 having been pre-trained, and a plurality of parameter arrays M1-Mn corresponding to the original image 101 are output by the parameter extraction model 102. Then, in operation S12, the original image 101 was enhanced by a sequence of image enhancement operations O1-On using the parameter arrays M1-Mn to obtain the enhanced image 105.

The parameter arrays M1-Mn has the same resolution as the original image 101, and each element of each parameter array is the parameter required in subsequent operations to perform a specific transformation of the corresponding pixels of the original image 101. In other words, each element of the parameter array Mi (i is any integer in 1 to n) indicates how the corresponding pixel of the original image 101 is enhanced by the image enhancement operation Oi corresponding to the parameter array Mi. More specifically, the elements in column i, row j of the parameter array M1 are used to enhance the pixel in column i, row j of the original image 101 as the image enhancement operation O1, and the elements of column i, row j of the parameter array M2 are used to enhance the pixels in column i, row j of the original image 101 as the image enhancement operation O2, and so on. In this way, pixel-wise image enhancement may be achieved in operation S12, replacing the indiscriminate enhancement of the whole image of the prior art.

The parameter extraction model 102 for extracting the parameter arrays M1-Mn may be implemented in any convolutional neural network (CNN). The reason why the parameter arrays M1-Mn may achieve pixel-wise image enhancement is that the convolution operation carried out by the convolutional neural network is to traverse all the pixels of the original image 101 in batches. Taking the 3*3 kernel as an example, a convolution operation considers the 9 pixels of the original image 101 (more specifically, one 3×3 patch (i.e., 9 pixels) from the original image 101 is element-wise multiplied with the 9 weights of the 3×3 kernel, and the results are summed to produce a single convolution value). As a result, a convolution value is obtained and assigned to the element of the parameter array. The convolutional neural network's algorithm then causes the kernel to slide a few pixels to the right along the original image 101 (note: the number of pixels that slides is called a “stride”), considers the next batch of 9 pixels to arrive at the next convolution value, and sets the next element of the parameter array to this convolution value. This process continues until the entire row of the original image 101 has been traversed. The convolution kernel then moves to the beginning of the next row and slides from left to right again. The above process is repeated until the entire original image 101 has been traversed by the kernel. During the training of the parameter extraction model 102, the algorithm will perform backpropagation to adjust the weight of the kernel according to the merits of each inference result (i.e., the loss value calculated by the loss function, which will be described in more detail later). Specifically, the parameters of the kernel are updated according to the gradient information of the loss function to reduce the loss value and improve model prediction accuracy. This process continues until the inference results meet the predetermined performance criteria.

In one of the embodiments, the parameter extraction model 102 is implemented in a convolutional neural network with a U-net structure, which includes an encoder and a decoder. The encoder consists of multiple convolutional layers to extract the feature representation of images, also known as a feature map. In addition to convolutional layers, pooling layers may be configured with an appropriate number of layers to reduce the spatial dimension of the feature map and preserve the most important feature information. In the process of encoding, the spatial information gradually decreases and the feature information gradually increases. The decoder includes multiple upsampling layers that map the feature map generated by the encoder back to the spatial dimension of the original image 101. Each upsampled layer is paired with a deconvolution layer for feature reconstruction and marginal smoothing. In addition, the feature map output by each upsampled layer will be concated with the feature map of the encoder of the previous layer to integrate the spatial information and feature information of each layer into the reconstruction consideration. In the process of decoding, the number of channels of the feature map gradually decreases, and the resolution gradually increases, and finally the parameter arrays M1-Mn with the same resolution as the original image 101 is generated.

It should also be understood that the original image 101 may have multiple channels. A typical example is a color image defined in the RGB color space, which contains three channels R(red), G(green), B(blue). In operation S12, a corresponding image enhancement operation may be performed on a specific channel of the original image 101, or the same image enhancement may be performed on each channel of the original image 101, but this disclosure is not limited to this. For example, if individual R/G/B channels are to be processed, the parameter arrays M1-Mn generated by the parameter extraction model 102 may be further divided into M1R/M1G/M1B, M2R/M2G/M2B, . . . , MnR/MnG/MnB, wherein the R/G/B after the parameter arrays M1-Mn corresponds to the R/G/B channels respectively. Therefore, if only the G-channel image enhancement is performed, the image enhancement operations O1, O2 . . . On is performed on the G-channel image of the original image respectively based on the elements indicated by the parameter arrays M1G, M2G, . . . , MnG. In addition, if only the R/G-channel image enhancement process is performed (i.e., the image of the B channel is not processed), the image enhancement operations O1, O2 . . . On is performed on the R/G-channel image of the original image respectively based on the elements indicated by the parameter arrays M1R/M1G, M2R/M2G, . . . , MnR/MnG.

Refer back to FIG. 1A and FIG. 1B. In operation S13, the enhanced image 105 is input to an image analysis model 106 having been pre-trained, and the inference result 107 output by the image analysis model 106 is obtained.

The image analysis model 106 can be any model used to extract meaningful information from images, such as an object detection model, an object recognition model, and distance (or depth) estimation model, but this disclosure does not limit this. Taking the application scenario of autonomous driving as an example, the original image 101 may be the image data that is returned by the sensor or camera mounted on the vehicle for the image analysis model 106 to carry out environmental perception related tasks. The object detection model is used to detect and locate various objects on the road, such as vehicles, pedestrians, obstacles, etc., to assist the vehicle in planning the optimal driving path, avoiding obstacles, and improving driving safety. When the image analysis model 106 is an object detection model, inference result 107 of the output is the position and range information of the object in the original image 101, usually represented in the form of a bounding box. Object recognition models further take environmental understanding to the next level, not only detecting the presence of objects, but also classifying them to support decision-making. For example, an object recognition model may be used to identify: the type of vehicle coming from behind, such as an ambulance, fire truck, or typical vehicle; the color of the traffic signal, such as a red, yellow or green light; various Road traffic signs, such as no parking, do not enter, road construction, etc.; and various types of pavement markings, including lane lines and crosswalks. When the image analysis model 106 is an object recognition model, the inference result 107 of its output is the category of the object, for example, the oncoming vehicle in the original image 101 is an ambulance, a fire truck or a typical vehicle, or for example, the traffic signal in the original image 101 is a red, yellow or green light. Distance estimation models are used to estimate the distance or depth information between the vehicle and surrounding objects to support the decision-making for automatic following (e.g., maintain a safe following distance from the vehicle ahead) and decision-making for automated parking (e.g., avoiding scraping or colliding with surrounding vehicles or walls). When the image analysis model 106 is a distance estimation model, the inference result 107 is the estimated distance between the camera and the object in the original image 101.

The machine learning algorithm used to build the image analysis model 106 depends on the type of tasks of the image analysis model 106. For example, when the image analysis model 106 is an object detection model, algorithms such as Faster R-CNN, YOLO (You Only Look Once), SSD (Single Shot MultiBox Detector), FPN (Feature Pyramid Networks) and other algorithms may be used to implement the training of image analysis model 106; when the image analysis model 106 is an object recognition model, such as convolutional neural networks (CNN) implements feature extractor, using decision tree, logistic regression, naive bayes, random forest, and support vector machine (SVM) or full-connected neural network as a classifier to implement the training of image analysis model 106; when the image analysis model 106 is a distance estimation model, such as convolutional neural network, multilayer perceptron (MLP), Recurrent Neural Network (RNN), Convolutional Recurrent Neural Network (CRNN) may be adopted to implement the training of image analysis model 106. In addition, gradient descent (GD) (e.g., Stochastic gradient descent (SGD) or adaptive moment estimation (Adam)) maybe used to calculate the gradient, thereby determining the direction of parameter optimization of the model in the training process of the model. For example, the weights of a neural network may be updated by backpropagation to minimize the loss.

The training dataset used to train the parameter extraction model 102 and the image analysis model 106 may contain multiple training data (e.g., training images with overexposed caused by the aforementioned light sources such as street lights or car headlights at night, products containing small local defects, or objects that are visually similar to the background), each training data contains the training image and the label data corresponding to the training image. The form of the label data depends on the type of task of the image analysis model 106. For example, when the image analysis model 106 is an object detection model, the label data is the position and range information of the object in the training image, which is usually represented by a bounding box. When the image analysis model 106 is an object recognition model, the label data is the category of the object, for example, the rear oncoming vehicle in the image is an ambulance, a fire truck or a typical vehicle, or for example, the traffic signal in the image is a red light, a yellow light or a green light; when the image analysis model 106 is the distance estimation model, the label data is the real distance between the camera and the object in the training image.

As shown in FIG. 1B, the parameter extraction model 102 and the image analysis model 106 were trained using the same loss function 108. More specifically, the training of the parameter extraction model 102 and the image analysis model 106 is end-to-end learning, and the same loss function 108 is used as the evaluation metric and constraints of the parameter extraction model 102 and the image analysis model 106. Thus, the parameter extraction model 102 may actively adapt to the image analysis model 106 without human intervention to adjust the parameters. In addition, the overall performance of the image analysis model 106 and its adaptability to various scenarios may also be effectively improved.

The loss function 108 is used to evaluate the discrepancy between the model outputs and the ground truth label data during training, also depending on the task type of the image analysis model 106. For example, when the image analysis model 106 is an object recognition model, the loss function 108 may be, such as cross-entropy (CE) loss, contrastive loss, hinge loss, or Kullback-Leibler divergence, which are commonly used for classification tasks. When the image analysis model 106 is a distance estimation model, the loss function 108 may be, such as the Mean Squared Error (MSE), Mean Absolute Error (MAE), Huber Loss, or Log-Cosh Loss, which are commonly used for loss functions for regression tasks.

In one of the embodiments, the image enhancement operations O1-On contains a denoising action, and the parameter arrays M1-Mn also contains a parameter array corresponding to the denoising action, hereinafter referred to as the “first parameter array”. Denoising is used to remove noise from an image. In one embodiment, each element in the array of first parameters is a binary value, i.e., 0 or 1, which indicates whether the pixel is noisy or not. In another embodiment, each element in the first parameter array is mapped to either 0 or 1 by going through the sigmoid activation function and then using 0.5 as the threshold. For pixels indicated as noisy by the first parameter array, bilinear interpolation may be used to replace the value of the point with a weighted average of the pixel values of its four adjacent pixels, where the weights are inversely proportional to the distance. Other interpolation methods may also be used for denoising, such as nearest-neighbor interpolation or bicubic interpolation, but this disclosure is not limited to this.

In one of the embodiments, the image enhancement operations O1-On contains a contrast adjustment action, and the parameter arrays M1-Mn also contains a parameter array corresponding to the contrast adjustment action, hereinafter referred to as the “second parameter array”. Contrast adjustment is used to adjust the contrast of an image, that is, the difference between light and dark in an image. In one implementation, contrast adjustment involves multiplying the pixel values of the image by the value of the corresponding elements in the second parameter array. When the value is greater than 1, it results in contrast enhancement at the corresponding pixel locations; When the value is less than 1, it results in a reduction of contrast at the corresponding pixel locations; When this value is equal to 1, the contrast of the corresponding pixel remains unchanged. In other implementations, different contrast adjustment functions may be used, such as logarithmic transformation or exponential transformation, where the second parameter array is used as a parameter of the contrast adjustment function.

In one of the embodiments, the image enhancement operations O1-On contains a brightness adjustment operation, and the parameter arrays M1-Mn also contains a parameter array corresponding to the brightness adjustment operation, hereinafter referred to as the “third parameter array”. Brightness adjustment is used to adjust the brightness of an image, i.e. how bright or dark the image is. In one of the implementations, the brightness adjustment involves adding the pixel values of the image to the values of the corresponding elements in the third-parameter array. When the value is greater than 0, it corresponds to an increase in the brightness of the corresponding pixel. When the value is less than 0, it corresponds to a decrease in brightness; when this value is equal to 0, the brightness of the corresponding pixel remains unchanged. In other implementations, different brightness adjustment functions, such as logarithmic or exponential transformations, may be used to adjust the brightness, with the third parameter array as a parameter of the brightness adjustment function.

In one implementation, both the contrast adjustment operation and the brightness adjustment operation use a linear transformation, in other words, the contrast adjustment operation involves multiplying the pixel values of the image by the corresponding elements in a second parameter array, while the brightness adjustment involves adding the pixel values of the image to the corresponding elements in a third parameter array. Therefore, contrast adjustment and brightness adjustment may be done at the same time.

In one of the embodiments, the image enhancement operations O1-On contains a sharpening operation, and the parameter arrays M1-Mn also contains a parameter array corresponding to the sharpening operation, hereinafter referred to as the “fourth parameter array”. The sharpening operation is used to enhance the visibility of edge contours in an image. In one implementation, the sharpening operation involves applying Gaussian Blur to an image to obtain a blurred image, subtracting the pixel values of the blurred image from the original image to obtain a contrast image, multiplying the pixel values of the contrast image by the corresponding elements in a fourth parameter array, and adding the pixel values of the original image. In other implementations, various filters may be used to enhance the high-frequency information in the image to achieve the sharpening effect, wherein the fourth parameter array is used as the parameter of the filter.

It should be understood that the operations of the above-mentioned denoising, contrast adjustment, brightness adjustment and sharpening are only some of the implementations of image enhancement, but this disclosure is not limited to this. In addition, the various embodiments disclosed herein do not limit the order of the execution between a plurality of image enhancements.

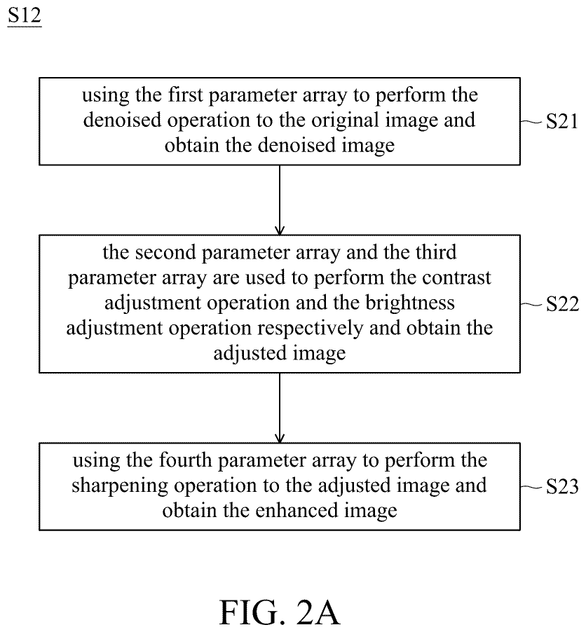

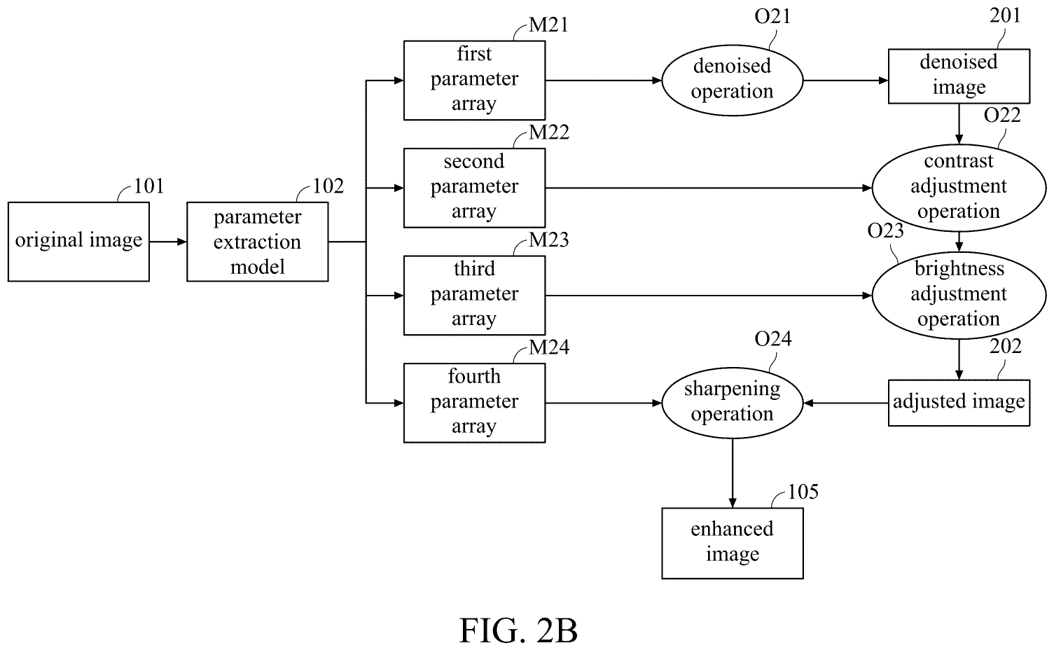

In one of the embodiments, the parameter arrays M1-Mn output by the parameter extraction model 102 includes the first parameter array, the second parameter array, the third parameter array and the fourth parameter array, and the image enhancement operations O1-On includes the operations of the above-mentioned denoising, contrast adjustment, brightness adjustment and sharpening. This embodiment is illustrated below with reference to FIG. 2A and FIG. 2B.

FIG. 2A illustrates a block diagram of flow in more detailed operations of operation S12 in one of the embodiments. FIG. 2B corresponds to FIG. 2A and depicts a flowchart of the more detailed operations of S12. Please refer to both FIG. 2A and FIG. 2B for a better understanding of the embodiments of this disclosure. As shown in FIG. 2A, operation S12 may contain operations S21-S23.

In operation S21, a denoising operation O21 is performed on the original image 101 using the first parameter array, resulting in a denoised image 201.

In operation S22, the second parameter array M22 and the third parameter array M23 are used to perform the contrast adjustment operation O22 and the brightness adjustment operation O23 respectively and obtain the adjusted image 202.

In Step S23, a sharpening operation O24 is performed on the adjusted image 202 using the fourth parameter array M24, thereby obtaining an enhanced image 105.

In this embodiment, multiple aspects of the original image 101, including brightness, contrast, and sharpness, can be simultaneously enhance. This not only ensures the recognition of image details, but also helps prevent issues such as halo artifacts and noise amplification caused by excessive local enhancement, thereby maintaining the performance of the image analysis model 106.

In one of the embodiments, the image enhancement method 10 is applied only to the images requiring enhancement. In other words, only the images requiring enhancement is listed as the original image 101, and the image that does not require enhancement may be directly input into the image analysis model for inference. As to whether an image require enhancement, it may be determined by the well-known various tools used to evaluate the signal-to-noise ratio, contrast, brightness, sharpness or other image attributes of the image, and this disclosure does not limit the evaluation tools used above. More specifically, in this embodiment, an image that satisfies any (or more) of the following conditions may be classified as an original image 101: (1) the signal-to-noise ratio is lower than the specified signal-to-noise ratio threshold; (2) The contrast is lower than the specified contrast threshold; (3) The image contains an overexposed area, and the brightness value of each pixel in the overexposed area is higher than the specified brightness threshold; and/or (4) the sharpness is below the specified sharpness threshold.

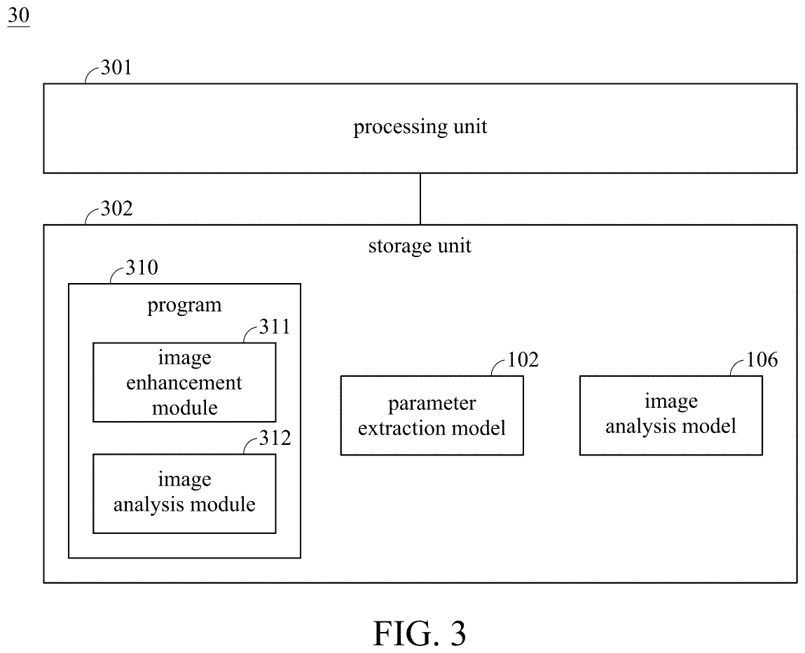

FIG. 3 is a system block diagram of an image analysis system 30 according to one of the embodiments of this disclosure. As shown in FIG. 3, the image analysis system 30 may include a processing unit 301 and a storage unit 302 coupled to each other. The storage unit 302 stores a program 310, which contains an image enhancement module 311 and an image analysis module 312. In addition, the storage unit may also store the aforementioned parameter extraction model 102 and image analysis model 106.

An image analysis system 30 may be any kind of computer system with computing power, such as a personal computer (such as a desktop computer or laptop) a server computer, or a mobile device such as a tablet or smartphone, but this disclosure is not limited to this.

The processing unit 301 may contain any one or more general-purpose or specialized processors and combinations thereof used to execute instructions. In a typical embodiment, the processing unit may contain a central processing unit (CPU) and a graphics processing unit (GPU), where the GPU is more efficient than the CPU in processing machine learning-related tasks. Therefore, appropriate tasks can be assigned according to the characteristics of the CPU and GPU—for example, tasks such as acquiring image data or communicating with other devices can be assigned to the CPU, while tasks related to image analysis and model training can be assigned to the GPU. In a further embodiment, the processing unit 301 may further contain a neural network processing unit (NPU) optimized specifically for deep learning. Compared to GPUs, an NPU may offer better computational performance when running deep neural networks, Therefore, tasks related to deep neural networks can be assigned to the NPU.

The storage unit 302 may be any kind of memory that contains non-volatile memory (e.g., read-only memory, electrically-erasable programmable read-only memory (EEPROM)), flash memory, non-volatile random access memory (NVRAM), such as hard disk drives (HDDs), solid-state drives (SSDs) or optical discs, which are not limited by this disclosure.

Program 310 is a sequence or set of instructions for a computer system to execute. In various embodiments, program 310 may be written in any one or more programming languages, such as Java, C, C#, C++, Python, etc., but this disclosure is not limit to this. When the processing unit 301 loads program 310 from the storage unit 302, an image enhancement module 311 and an image analysis module 312 may be executed, whereby the image enhancement module 311 corresponds to operation Si 1 and operation S12, and the image analysis module 312 corresponds to operation S13. Thus, when the processing unit 301 loads program 310 from the storage unit 302, operations S11-S13 may be performed.

In one of the embodiments, the program 310 may further contain a model building module, although it is not shown in FIG. 3. During the execution of the model building module, the processing unit 301 uses the aforementioned loss function 108 and the training dataset to train the parameter extraction model 102 and the image analysis model 106.

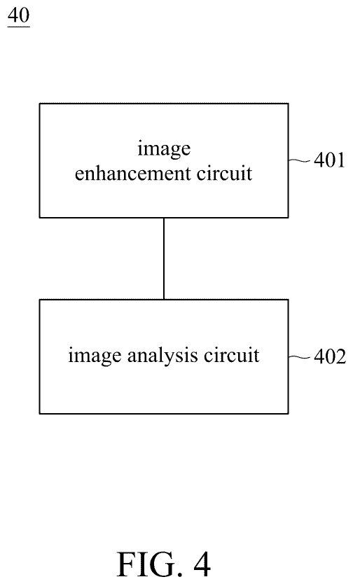

The FIG. 4 is a system block diagram of an image analysis system 40 according to one of the embodiments of this disclosure. As shown in the FIG. 4, the image analysis system 40 contains an image enhancement circuit 401 and an image analysis circuit 402 coupled to each other.

The image enhancement circuit 401 and the image analysis circuit 402 may be implemented by one or more specialized electronic circuits, such as application-specific integrated circuits (ASIC), filed-programmable gate array (FPGA) and/or various logic circuits. The image enhancement circuit 401 is set to perform operation S11 and operation S12, and the image analysis circuit 402 is set to perform operation S13.

The image analysis system provided by the various embodiments disclosed herein may not only prevent excessive enhancement and overexposure of light source areas caused by brightness enhancement in dark regions of nighttime images, but may also be applicable to scenarios in which the subject resembles the background. This approach thereby addresses the limitations. This approach thereby addresses the limitations of conventional methods that perform indiscriminate enhancement on the entire image, which often results in poor image analysis performance. In addition, the trained model may be deployed on the edge device or terminal device for independent execution in practical application, which can not only achieve economic benefits, but also protect the critical information of the enterprises.

The foregoing paragraphs describe various aspects. It is evident that the teachings of this document can be implemented in a variety of ways, and any specific architecture or function disclosed in the examples is merely a representative instance. According to the teachings of this document, it should be understood that the various embodiments disclosed in this article may be implemented independently or in combination.

While the disclosure has been described above with reference to embodiments, it is not intended to limit the disclosure. Those skilled in the art can make some modifications and refinements without departing from the spirit and scope of the disclosure. Therefore, the scope of protection of the invention shall be defined by the appended claims.

What is claimed is:

1. An image analysis system, comprising:
a storage unit; and
a processing unit,
wherein the processing unit is configured to load a program from the storage unit to operate:
an image enhancement module, configured to input an original image into a parameter extraction model having been pre-trained, and to obtain a plurality of parameter arrays corresponding to the original image output by the parameter extraction model, and to perform a sequence of image enhancement operations on the original image using the parameter arrays to obtain an enhanced image, wherein each parameter array has the same resolution as the original image, and each element of the parameter array is a parameter required to perform an image enhancement operation corresponding to the parameter array on the corresponding pixel of the original image; and
an image analysis module, configured to input the enhanced image into an image analysis model having been pre-trained, and to obtain an inference result output by the image analysis model.

2. The image analysis system as claimed in claim 1, wherein the parameter extraction model and the image analysis model are trained using a loss function that is the same for both.

3. The image analysis system as claimed in claim 2, wherein the processing unit is further configured to operate:
a model building module, configured to use the loss function and a training dataset to train the parameter extraction model and the image analysis model, wherein the training dataset comprises a plurality of training data, and each training data comprises a training image and label data corresponding to the training image.

4. The image analysis system as claimed in claim 1, wherein the image enhancement operations comprise a denoising operation; and
wherein the parameter arrays comprise a first parameter array for performing the denoising operation.

5. The image analysis system as claimed in claim 1, wherein the image enhancement operations comprise a contrast adjustment operation; and
wherein the parameter arrays comprise a second parameter array for performing the contrast adjustment operation.

6. The image analysis system as claimed in claim 1, wherein the image enhancement operations comprise a brightness adjustment operation; and
wherein the parameter arrays comprise a third parameter array for performing the brightness adjustment operation.

7. The image analysis system as claimed in claim 1, wherein the image enhancement operations comprise a sharpening operation; and
wherein the parameter arrays comprise a fourth parameter array for performing the sharpening operation.

8. The image analysis system as claimed in claim 1, wherein the parameter arrays comprise a first parameter array, a second parameter array, a third parameter array and a fourth parameter array, the image enhancement operations comprise a denoising operation, a contrast adjustment operation, a brightness adjustment operation and a sharpening operation; and
wherein the processing unit is configured to use the first parameter array to:
perform the denoising operation on the original image to obtain a denoised image;
use the second parameter array and the third parameter array to adjust the contrast and the brightness of the denoised image respectively to obtain an adjusted image; and
use the fourth parameter array to perform the sharpening operation on the adjusted image to obtain the enhanced image.

9. The image analysis system as claimed in claim 1, wherein a signal-to-noise ratio of the original image is lower than a specified signal-to-noise ratio threshold;
wherein a contrast of the original image is lower than a specified contrast threshold;
wherein the original image contains an overexposed area, a brightness value of each pixel in the overexposed area is higher than a specified brightness threshold; and/or
wherein a sharpness of the original image is lower than a specified sharpness threshold.

10. An image analysis system, comprising:
an image enhancement circuit is configured to:
input an original image into a parameter extraction model having been pre-trained;
obtain a plurality of parameter arrays corresponding to the original image output by the parameter extraction model; and
perform a sequence of image enhancement operations on the original image using the parameter arrays to obtain an enhanced image, wherein each parameter array has the same resolution as the original image, and each element of the parameter array is a parameter required to perform an image enhancement operation corresponding to the parameter array on the corresponding pixel of the original image; and
an image analysis circuit, coupled to the image enhancement circuit and configured to input the enhanced image into an image analysis model having been pre-trained to obtain an inference result output by the image analysis model.

11. The image analysis system as claimed in claim 10, wherein the parameter extraction model and the image analysis model are trained using a loss function that is the same for both.

12. The image analysis system as claimed in claim 10, wherein the image enhancement operation comprises a denoising operation; and
wherein the parameter arrays comprise a first parameter array for performing the denoising operation.

13. The image analysis system as claimed in claim 10, wherein the image enhancement operations comprise a contrast adjustment operation; and
wherein the parameter arrays comprise a second parameter array for performing the contrast adjustment operation.

14. The image analysis system as claimed in claim 10, wherein the image enhancement operations comprise a brightness adjustment operation; and
wherein the parameter arrays comprise a third parameter array for performing the brightness adjustment operation.

15. The image analysis system as claimed in claim 10, wherein the image enhancement operations comprise a sharpening operation; and
wherein the parameter arrays comprise a fourth parameter array for performing the sharpening operation.

16. The image analysis system as claimed in claim 10, wherein the parameter arrays comprise a first parameter array, a second parameter array, a third parameter array and a fourth parameter array, the image enhancement operations comprise a denoising operation, a contrast adjustment operation, a brightness adjustment operation and a sharpening operation; and
wherein the image enhancement circuit is configured to use the first parameter array to:
perform the denoising operation on the original image to obtain a denoised image;
use the second parameter array and the third parameter array to adjust the contrast and the brightness of the denoised image respectively to obtain an adjusted image; and
use the fourth parameter array to perform the sharpening operation on the adjusted image to obtain the enhanced image.

17. The image analysis system as claimed in claim 10, wherein a signal-to-noise ratio of the original image is lower than a specified signal-to-noise ratio threshold;
wherein a contrast of the original image is lower than a specified contrast threshold;
wherein the original image contains an overexposed area, a brightness value of each pixel in the overexposed area is higher than a specified brightness threshold; and/or
wherein a sharpness of the original image is lower than a specified sharpness threshold.

18. An image analysis method, performed by an image analysis system, the method comprising:
inputting an original image into a parameter extraction model having been pre-trained to obtain a plurality of parameter arrays corresponding to the original image output by the parameter extraction model;
performing a sequence of image enhancement operations on the original image using the parameter arrays to obtain an enhanced image, wherein each parameter array has the same resolution as the original image, each element of the parameter array is a parameter required to perform an image enhancement operation corresponding to the parameter array on the corresponding pixel of the original image; and
inputting the enhanced image into an image analysis model having been pre-trained to obtain an inference result output by the image analysis model.

19. The image analysis method as claimed in claim 18, wherein the parameter extraction model and the image analysis model are trained using a loss function that is the same for both.

20. The image analysis method as claimed in claim 19, further comprising:
using the loss function and a training dataset to train the parameter extraction model and the image analysis model, wherein the training dataset comprises a plurality of training data, and each training data comprises a training image and label data corresponding to the training image.

21. The image analysis method as claimed in claim 18, wherein the image enhancement operations comprise a denoising operation; and
wherein the parameter arrays comprise a first parameter array for performing the denoising operation.

22. The image analysis method as claimed in claim 18, wherein the image enhancement operation comprises a contrast adjustment operation; and
wherein the parameter arrays comprise a second parameter array for performing the contrast adjustment operation.

23. The image analysis method as claimed in claim 18, wherein the image enhancement operation comprises a brightness adjustment operation; and
wherein the parameter arrays comprise a third parameter array for performing the brightness adjustment operation.

24. The image analysis method as claimed in claim 18, wherein the image enhancement operation comprises a sharpening operation; and
wherein the parameter arrays comprise a fourth parameter array for performing the sharpening operation.

25. The image analysis method as claimed in claim 18, wherein the parameter arrays comprise a first parameter array, a second parameter array, a third parameter array and a fourth parameter array, and the image enhancement operations comprise a denoising operation, a contrast adjustment operation, a brightness adjustment operation and a sharpening operation; and
wherein the step of performing the image enhancement operations on the original image using the parameter arrays to obtain the enhanced image further comprises:
performing the denoising operation on the original image using the first parameter array to obtain a denoised image;
performing the contrast adjustment operation and the brightness adjustment operation on the denoised image using the second parameter array and the third parameter array respectively to obtain an adjusted image; and
performing the sharpening operation on the adjusted image using the fourth parameter array to obtain the enhanced image.

26. The image analysis method as claimed in claim 18, wherein a signal-to-noise ratio of the original image is lower than a specified signal-to-noise ratio threshold;
wherein a contrast of the original image is lower than a specified contrast threshold;
wherein the original image contains an overexposed area, a brightness value of each pixel in the overexposed area is higher than a specified brightness threshold; and/or
wherein the sharpness of the original image is lower than the specified sharpness threshold.
